(19) United States
(12) Patent Application Publication
(10) Pub. No.: US 2019/0049561 A1
(43) Pub. Date: Feb. 14, 2019

(54) FAST LIDAR DATA CLASSIFICATION

(71) Applicant: Intel Corporation, Santa Clara, CA (US)

(72) Inventor: Rony Ferzli, Chandler, AZ (US)

(73) Assignee: Intel Corporation, Santa Clara, CA (US)

(21) Appl. No.: 15/856,526

(22) Filed: Dec. 28, 2017

(51) Int. Cl. G01S 7/48

(52) U.S. Cl. CPC G01S 7/4808; G01S 17/89

(57) ABSTRACT

A controller comprises a communication interface to receive a lidar dataset comprising a plurality of intensity measurement data points; and processing circuitry to implement an iterative process to determine a second central moment and a fourth central moment of at least a portion of the dataset of intensity measurement data points, determine a kurtosis of the at least a portion of the dataset of intensity measurement data points using the second central moment and the fourth central moment, identify an intensity measurement data point which has the highest intensity in the at least a portion of the dataset of intensity measurement data points, and remove from the at least a portion of the data set the intensity measurement data point which has the highest intensity in the at least a portion of the dataset of intensity measurement data points until the kurtosis converges to a predetermined value.

### BACKGROUND

The subject matter described herein relates generally to the field of electronic devices and more particularly to systems and methods for fast light detection and ranging (lidar) data classification.

Lidar is a detection system which uses a laser to measure distances of objects from a sensor, thereby producing highly accurate measurements. The output of a lidar system is a high-resolution three-dimensional (3D) map of a geographic region. Lidar may be used in a wide variety of applications in different technology areas. Recently, lidar has been applied to autonomous vehicles in the field of high definition (HD) mapping of a geographic region surrounding a vehicle.

Lidar produces mass point cloud datasets that can be managed, visualized, analyzed (i.e., for object detection). Because lidar algorithms generate datasets which comprise a very large number (e g millions) of data points to be analyzed it can be a challenge to develop data sorting algorithms that are suitably fast and that readily map to a hardware implementation.

Accordingly, systems and methods to implement fast lidar data classification may find utility, e.g., in HD mapping for autonomous vehicles.

### BRIEF DESCRIPTION OF THE DRAWINGS

The detailed description is described with reference to the accompanying figures.

FIG. 1 is a schematic illustration of an environment to implement fast lidar data classification for autonomous vehicles, in accordance with some examples.

FIG. 2 is a high-level schematic illustration of an exemplary architecture to implement fast lidar data classification for autonomous vehicles in accordance with some examples.

FIG. 3 is a flowchart illustrating operations in a method to implement fast lidar data classification for autonomous vehicles in accordance with some examples.

FIG. 4 is a diagram illustrating elements in an architecture to implement fast lidar data classification for autonomous vehicles in accordance with some examples.

FIG. 5 is a graphic depiction of a segmented point cloud for fast lidar data classification for autonomous vehicles in accordance with some examples.

FIGS. 6-10 are schematic illustrations of electronic devices which may be adapted for use in fast lidar data classification for autonomous vehicles in accordance with some examples.

### DETAILED DESCRIPTION

Described herein are examples of fast lidar data classification which, in some examples, may be used for autonomous vehicles. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

Described herein are techniques to process, and more particularly to classify, lidar data. In some examples a lidar data set (or subset) is analyzed using a particular adaptation of the kurtosis of the intensity values of the data set. A controller implements an iterative process of determining the kurtosis of the data set and then removing from the data set the data point which has the maximum intensity value until the kurtosis of the data set converges to a value of 3. The remaining data points in the data set may the be classified as a plane, e.g., a ground plane or another surface plane. The process may be repeated across different locations represented by a data set to help classify features of the image represented by the data set. Also described herein are specific implementations of processing circuitry to perform the calculations necessary to compute the kurtosis of the data sets in a way that is readily amenable to implementation in digital logic.

In one aspect, a controller comprises a communication interface to receive a lidar dataset comprising a plurality of intensity measurement data points; and processing circuitry to implement an iterative process to determine a second central moment and a fourth central moment of at least a portion of the dataset of intensity measurement data points, determine a kurtosis of the at least a portion of the dataset of intensity measurement data points using the second central moment and the fourth central moment, identify an intensity measurement data point which has the highest intensity in the at least a portion of the dataset of intensity measurement data points, and remove from the at least a portion of the data set the intensity measurement data point which has the highest intensity in the at least a portion of the dataset of intensity measurement data points until the kurtosis converges to a predetermined value.

In another aspect an autonomous vehicle comprises a lidar system to generate a lidar dataset comprising a plurality of intensity measurement data points; and a controller comprising a communication interface to receive the lidar dataset; and processing circuitry to implement an iterative process to determine a second central moment and a fourth central moment of at least a portion of the dataset of intensity measurement data points, determine a kurtosis of the at least a portion of the dataset of intensity measurement data points using the second central moment and the fourth central moments, identify an intensity measurement data point which has the highest intensity in the at least a portion of the dataset of intensity measurement data points, and remove from the at least a portion of the data set the intensity measurement data point which has the highest intensity in the at least a portion of the dataset of intensity measurement data points until the kurtosis converges to a predetermined value.

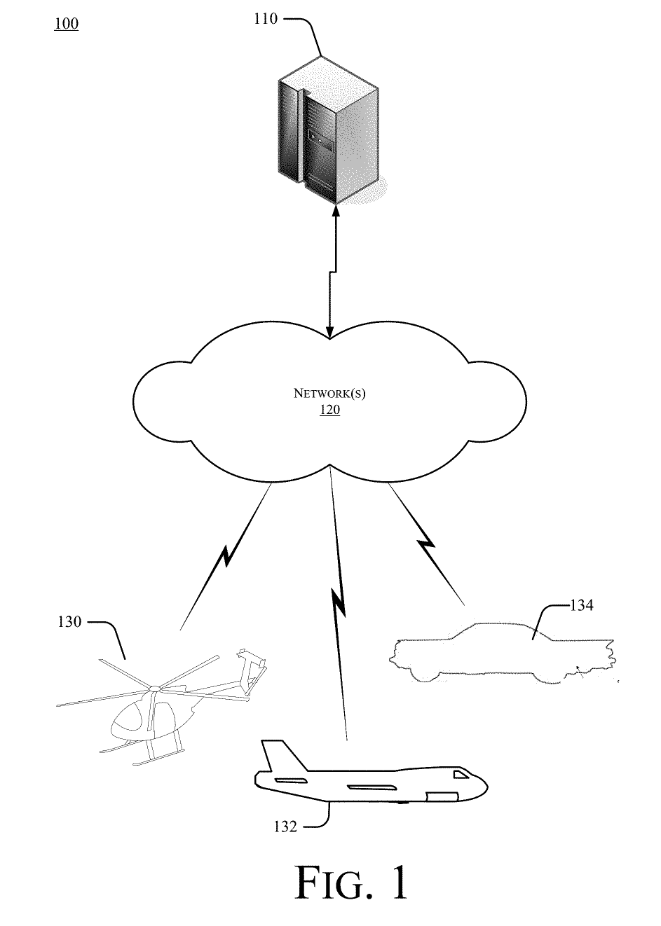

Subject matter described herein may be used advantageously with autonomous vehicles. As used herein, the term vehicle should be construed broadly to include cars, trucks, ships, aircrafts, spacecrafts, trains, buses or any form of transportation. Further structural and operational details will be described with reference to FIGS. 1-10, below.

FIG. 1 is a schematic illustration of an environment for fast lidar data classification for autonomous vehicles, in accordance with some examples. Referring to FIG. 1, in some examples the environment 100 comprises one or more cloud-based vehicle management systems 110 communicatively coupled to a communication network 120 capable of transmitting information from the vehicle management system(s) 110 to one or more autonomous vehicles such as a helicopter 130, an aircraft 132 or an automotive vehicle 134.

In some examples vehicle management system(s) 110 may comprise one or more processor-based devices, e.g., server(s) comprising computer-readable memory which stores software updates for one or more devices communicatively coupled to the one or more autonomous vehicles.

Network 120 may be embodied as a public communication network such as, e.g., the internet, or as a private communication network, such as a cellular network, or combinations thereof). In one or more examples, network 120 may operate in compliance with a Worldwide Interoperability for Microwave Access (WiMAX) standard or future generations of WiMAX, and in one particular example may be in compliance with an Institute for Electrical and Electronics Engineers 802.16-based standard (for example, IEEE 802.16e), or an IEEE 802.11-based standard (for example, IEEE 802.11 a/b/g/n standard), and so on. In one or more alternative examples, network 900 may be in compliance with a 3rd Generation Partnership Project Long Term Evolution (3GPP LTE), a 3GPP2 Air Interface Evolution (3GPP2 AIE) standard and/or a 3GPP LTE-Advanced standard. In general, network 900 may comprise any type of orthogonal-frequency-division-multiple-access-based (OFDMA-based) wireless network, for example, a WiMAX compliant network, a Wi-Fi Alliance Compliant Network, a digital subscriber-line-type (DSL-type) network, an asymmetric-digital-subscriber-line-type (ADSL-type) network, an Ultra-Wideband (UWB) compliant network, a Wireless Universal Serial Bus (USB) compliant network, a 4th Generation (4G) type network, and so on, and the scope of the claimed subject matter is not limited in these respects.

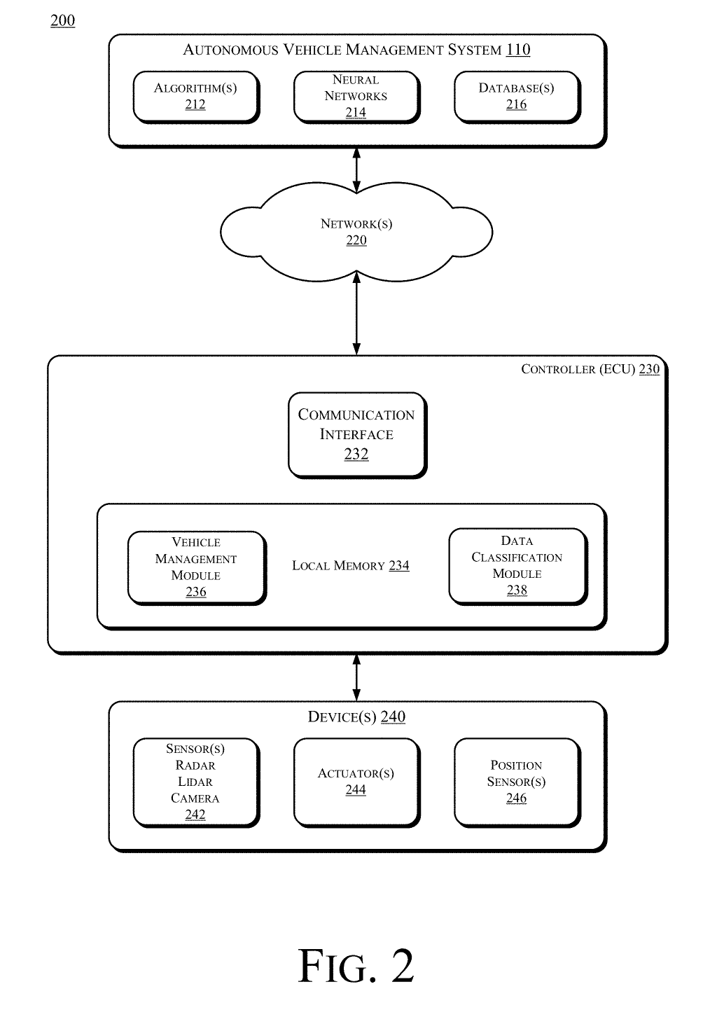

FIG. 2 is a high-level schematic illustration of an exemplary architecture to implement fast lidar data classification for autonomous vehicles in accordance with some examples. Referring to FIG. 2, in some examples the autonomous vehicle management system 110 may comprise one or more vehicle management algorithms 212 which may comprise software and/or firmware to manage devices on one or more autonomous vehicles. Vehicle management system 110 may comprise one or more neural networks 214 to manage devices on one or more autonomous vehicles. Vehicle management system 110 may further comprise one or more databases to manage data associated with devices on one or more autonomous vehicles.

Autonomous vehicle management system 110 is communicatively coupled to one or more controllers 230, also referred to sometimes as an electronic control unit (ECU), via communication network(s) 220. Network(s) 220 may be embodied as a public communication network such as, e.g., the internet, or as a private communication network, such as a cellular network, or combinations thereof.

Controller 230 may be incorporated into or communicatively coupled to an autonomous vehicle. Controller 230 may be embodied as general purpose processor such as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. Alternatively, controller 230 may be embodied as a low-power controller such as a field programmable gate array (FPGA) or the like.

Controller 230 may comprise a communication interface 232 to manage communication via network 220, a local memory 234, a vehicle management module 236, and a data classification module 238. Communication interface 232 may comprise, or be coupled to, an RF transceiver which may implement a communication connection via a protocol compliant with network 120 as described above or with a local communication protocol such as an Ethernet connection.

In some examples, local memory module 236 may comprise random access memory (RAM) and/or read-only memory (ROM). Memory 236 may be also be implemented using other memory types such as dynamic RAM (DRAM), synchronous DRAM (SDRAM), and the like. Memory 240 may comprise one or more applications including a vehicle management module 236 and a data classification module 238 may be implemented as logic instructions executable on controller 230, e.g., as software or firmware, or may be reduced to hardwired logic circuits.

Controller 230 may be coupled to one or more devices 240 on an autonomous vehicle. For example, devices 240 may include one or more sensor(s) (e.g., radar(s), lidar(s), camera(s)) 242, actuator(s)s 244, or position sensor(s) 246 (e.g., GPS, inertial sensors, etc.).

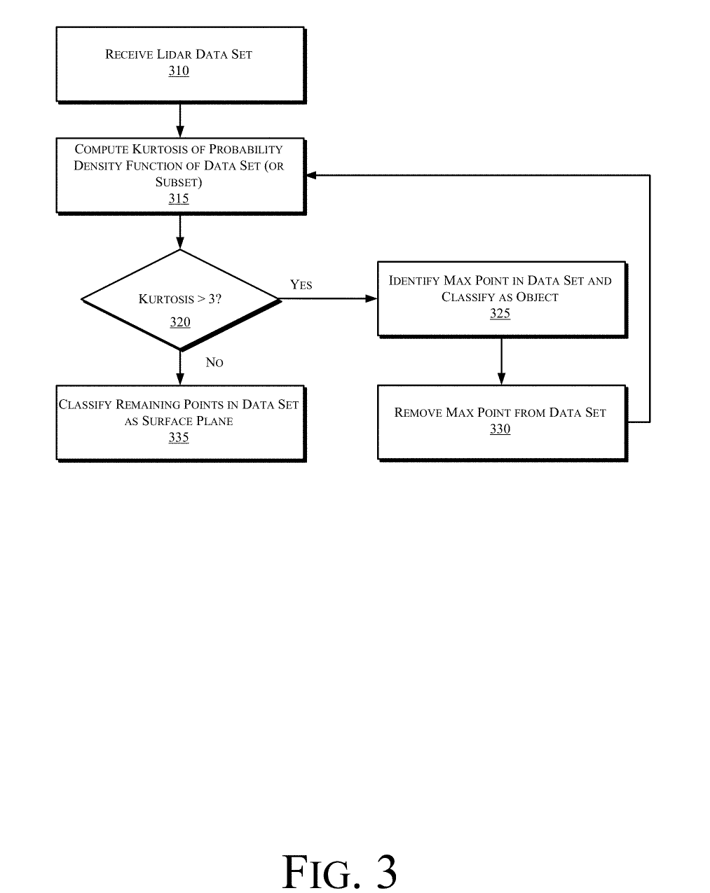

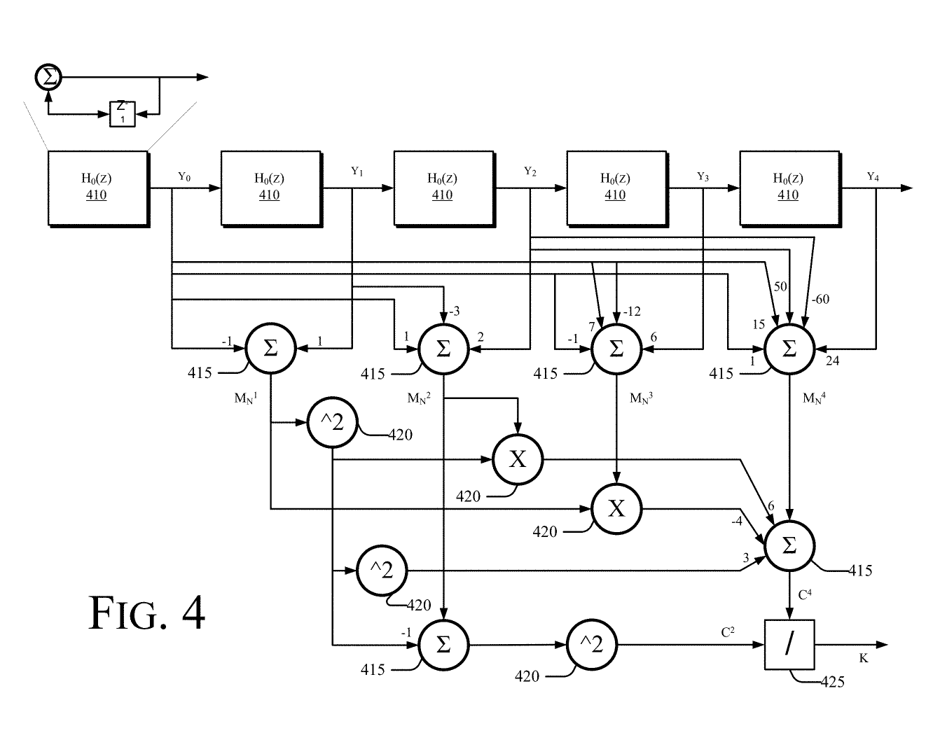

Having described various structural components of examples of an architecture for fast lidar data classification for autonomous vehicles, operations implemented by the system will be described with reference to FIGS. 3-4. In some examples some or all of the operations depicted in FIG. 3 may be implemented by the data classification module 238 which executes on the controller 230.

Referring to FIGS. 3-4, at operation 310 a lidar dataset is received. For example, controller 230 may receive a lidar dataset from a lidar device 242 via the communication interface 232. The lidar dataset may comprise a large number of data points, each of which represents an intensity of a reflection of a laser beam from an object at particular point in time, analogous to a pixel map gathered by a digital camera.

At operation 315 the kurtosis of the probability density function of the data set (or a subset thereof) is computed. For example, the data classification module 238 may select a subset of the data set which corresponds to a region of the pixel map represented by the data set and may compute the kurtosis of the data points in the subset which represents the region. One skilled in the art will recognize that the kurtosis of a dataset which represents a surface plane (e.g., the plane of the ground or the surface of an object) will have a measurement of 3. The presence of data points in the region which are reflected from objects above or below the surface plane will cause the kurtosis of the dataset to trend greater than 3.

If, at operation 320 the kurtosis of the data points in the subset of the region is greater than 3 then control passes to operation 325. At operation 325 the data point in the data set which has the maximum intensity value is identified and is classified as an object. At operation 330 the data point in the data set which has the maximum intensity value is removed from the data set. Control then passes back to operation 315 and the kurtosis of the data set is computed again. By contrast, if at operation 320 the kurtosis of the data set is 3 then the remaining points in the data set are classified as a surface plane.

Thus, the operations in FIG. 3 depict an iterative process of determining the kurtosis of a data set and then removing from the data set the data point which has the maximum intensity value until the kurtosis of the data set converges to a value of 3. The remaining data points in the data set may then be classified as a plane, e.g., a ground plane or another surface plane. The process may be repeated across different locations across the data set to help classify features of the image represented by the data set.

In some examples the process described herein adopts a specific definition of kurtosis that allows for ready implementation in digital logic. Given a univariate random variable ‘Y’ with mean μy and finite moments, the kurtosis of the data is defined as a normalized 4th moment of the dataset as Equation 1:

$$k = \frac{E [ {( Y - {μ}_{Y} )}^{4} ]}{{E [ {( Y - {μ}_{Y} )}^{2} ]}^{2}} \qquad EQ 1$$

Where ‘E’ is the expectation. The kurtosis can be rewritten in terms of central moments. The definition of a central moment of a distribution f(n) of length N+1 with respect to point n=N is given by Equation (2):

$${C}_{N}^{p} = {\sum }_{n = 0}^{N} {[ ( N - n ) - {M}_{N}^{1} ]}^{p} f ( n ) \qquad EQ 2$$

Applying the binomial theorem yields:

$$\begin{matrix}{C}_{N}^{p} = {\sum }_{n = 0}^{N} {\sum }_{k = 0}^{p} ( \begin{matrix}p \\ k\end{matrix} ) {( N - n )}^{k} {( - {M}_{N}^{1} )}^{p - k} f ( n ) \\ = {\sum }_{k = 0}^{p} ( \begin{matrix}p \\ k\end{matrix} ) {( - 1 )}^{p - k} {( {M}_{N}^{1} )}^{p - k} {\sum }_{n = 0}^{N} {( N - n )}^{k} f ( n ) \\ = {\sum }_{k = 0}^{p} ( \begin{matrix}p \\ k\end{matrix} ) {( - 1 )}^{p - k} {( {M}_{N}^{1} )}^{p - k} {M}_{N}^{k}\end{matrix} \qquad EQ 3$$

Equation (3) above gives the relation between the central and raw moments of interest, the 2nd and 4th central moments and given by:

C_{N}²=−(M_{N}¹)²+M_{N}²

C_{N}⁴=−3(M_{N}¹)⁴+6((M_{N}¹)²M_{N}²)−4(M_{N}¹M_{N}³)+M_{N}⁴

And the kurtosis, K, is then given by:

$$k = \frac{{C}_{N}^{4}}{{( {C}_{N}^{2} )}^{2}} \qquad EQ 4$$

In order to compute the kurtosis, the central moments must be computed, and to compute the central moments raw moments are computed first. An efficient architecture for raw moment can be achieved by using an infinite impulse response (IIR) recursive filter.

Referring to FIG. 4, to compute raw moments, a cascade of single pole IIR filters 410 may be used. The general formula of a (p+1) cascaded all pole filter is given as:

$${\hat{H}}_{p} ( z ) = \frac{1}{{( z - 1 )}^{p + 1}} \qquad EQ 5$$

For p=0, the following Z-transform pair results:

$${\hat{H}}_{0} ( z ) = \frac{1}{( z - 1 )} ⇔ {h}_{0} ( n ) = \hat{u} ( n - 1 ) \qquad EQ 6$$

The output of the filter in response to f(n) of length N+1 is:

$${y}_{0} ( n ) = {\sum }_{k = - ∞}^{+ ∞} f ( k ) u ( n - ( k - 1 ) ) = {\sum }_{k = 0}^{n - 1} f ( k ) \qquad EQ 7$$

Evaluating the output at n=N+1:

$${y}_{0} ( N + 1 ) = {\sum }_{k = 0}^{N} f ( k ) = {M}_{N}^{0} \qquad EQ 8$$

Which is the zero-order moment of f(n) with respect to N. Next, for the case of p=2 yields

$${\hat{H}}_{1} ( z ) = \frac{1}{{( z - 1 )}^{2}} = - \frac{\partial {\hat{H}}_{0} ( z )}{\partial z} = {z}^{- 1} ( - z \frac{\partial {\hat{H}}_{0} ( z )}{\partial z} )$$

Using the differentiation property of the Z-transform yields:

$$- z ( \frac{\partial H ( z )}{\partial z} ) ↔ nh ( n )$$

From the above a relationship between the impulse responses of the first and second order all pole filters can be derived as follows:

$$\begin{matrix}{\hat{h}}_{1} ( n ) = ( n - 1 ) {\hat{h}}_{0} ( n - 1 ) \\ = ( n - 1 ) u ( n - 2 ) \\ = ( n - 2 + 1 ) ( u ( n - 2 ) \\ = ( n - 2 ) u ( n - 2 ) + u ( n - 2 )\end{matrix}$$

The output of this filter will be:

$${y}_{1} ( n ) = {\sum }_{k = 0}^{n - 2} f ( k ) ( n - 2 - k ) + {\sum }_{k = 0}^{n - 2} f ( k )$$

The output evaluated at n=N+2 will be a linear combination of the first two moments of f(n):

$${y}_{1} ( N + 2 ) = {\sum }_{k = 0}^{N} f ( k ) ( N - k ) + {\sum }_{k = 0}^{N} f ( k ) == {M}_{N}^{1} + {M}_{N}^{0}$$

Proceeding in the same fashion, one can compute the linear combination for higher moments. The transformation matrix up to the forth moment is given by M=A·Y:

$$[ \begin{matrix}{M}_{N}^{0} \\ {M}_{N}^{1} \\ {M}_{N}^{2} \\ {M}_{N}^{3} \\ {M}_{N}^{4}\end{matrix} ] = {[ \begin{matrix}1 & 0 & 0 & 0 & 0 \\ 1 & 1 & 0 & 0 & 0 \\ 1 & \frac{3}{2} & \frac{1}{2} & 0 & 0 \\ 1 & \frac{11}{6} & 1 & \frac{1}{6} & 0 \\ 1 & \frac{50}{24} & \frac{35}{24} & \frac{10}{24} & \frac{1}{24}\end{matrix} ]}^{- 1} [ \begin{matrix}y 0 \\ y 1 \\ y 2 \\ y 3 \\ y 4\end{matrix} ] = [ \begin{matrix}1 & 0 & 0 & 0 & 0 \\ - 1 & 1 & 0 & 0 & 0 \\ 1 & - 3 & 2 & 0 & 0 \\ - 1 & 7 & - 12 & 6 & 0 \\ 1 & 15 & 50 & - 60 & 24\end{matrix} ] [ \begin{matrix}y 0 \\ y 1 \\ y 2 \\ y 3 \\ y 4\end{matrix} ] \qquad EQ 9$$

FIG. 4 illustrates a circuit architecture to compute raw moments using the output of the single pole IIR cascaded filter outputs 410. The computed raw moments are routed though summers 415, multipliers 420, and a divider 425 to compute kurtosis as illustrated in FIG. 4. The raw moment outputs generated by the single pole IIR filters 415 are directed to summers 415 as illustrated in FIG. 4 to generate the central moments M_{N}⁰ through M_{N}⁴. Note the single pole IIR filter is just accumulator with feedback delay, which can be implemented by a flip flop.

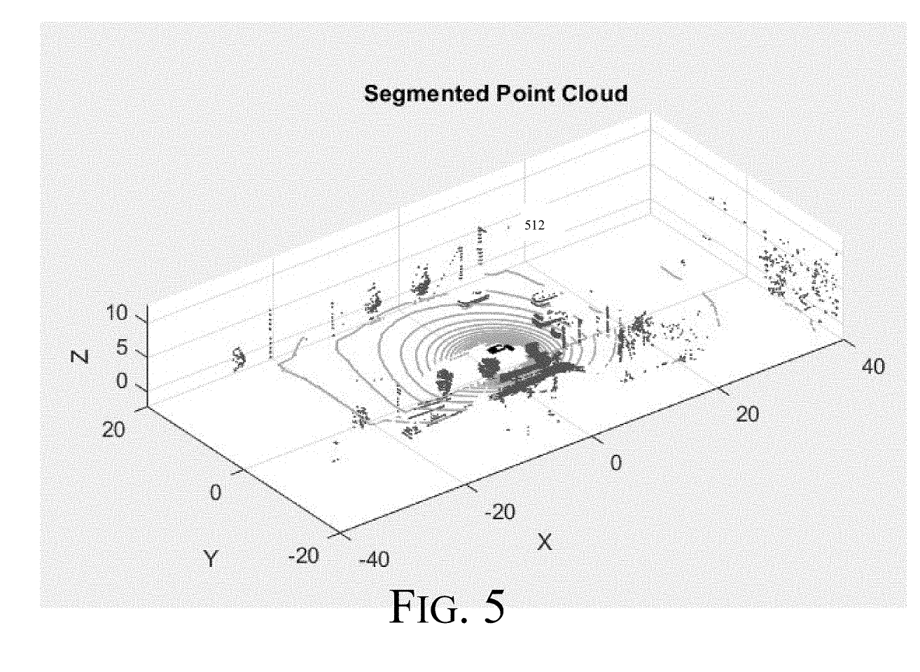

Thus, the circuitry depicted in FIG. 4 may be used to perform the necessary calculations to determine the kurtosis of a data set (or a subset thereof) as required by operation 315 of FIG. 3 in an efficient manner in digital logic. FIG. 5 is a graphic depiction of a segmented point cloud for fast lidar data classification for autonomous vehicles in accordance with some examples. As illustrated in FIG. 5, the method enables a fast classification of lidar data into objects and planes.

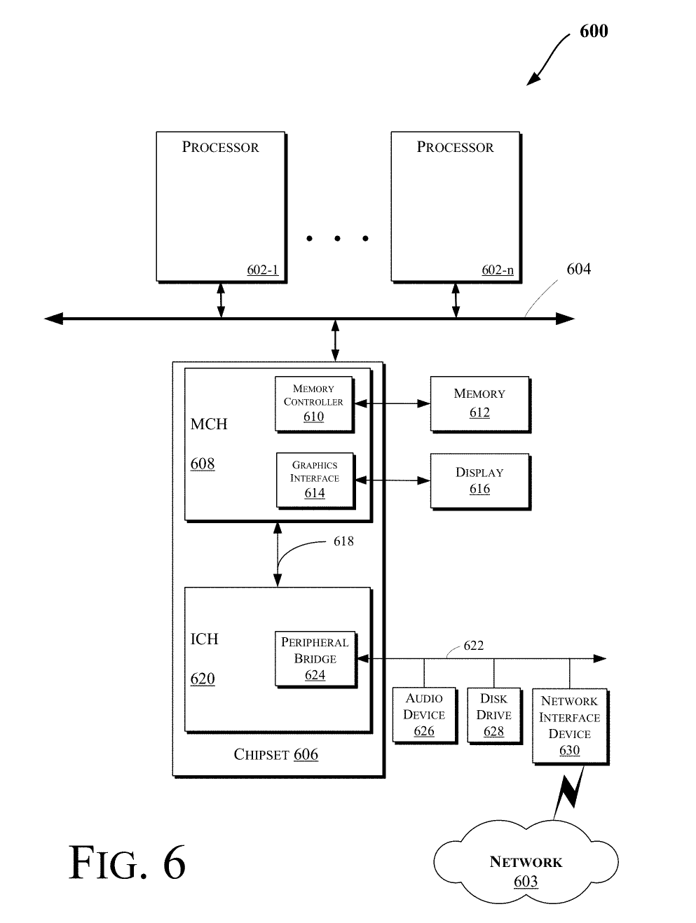

As described above, in some examples the controller 230 and may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors.

A chipset 606 may also communicate with the interconnection network 604. The chipset 606 may include a memory control hub (MCH) 608. The MCH 608 may include a memory controller 610 that communicates with a memory 612. The memory 412 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

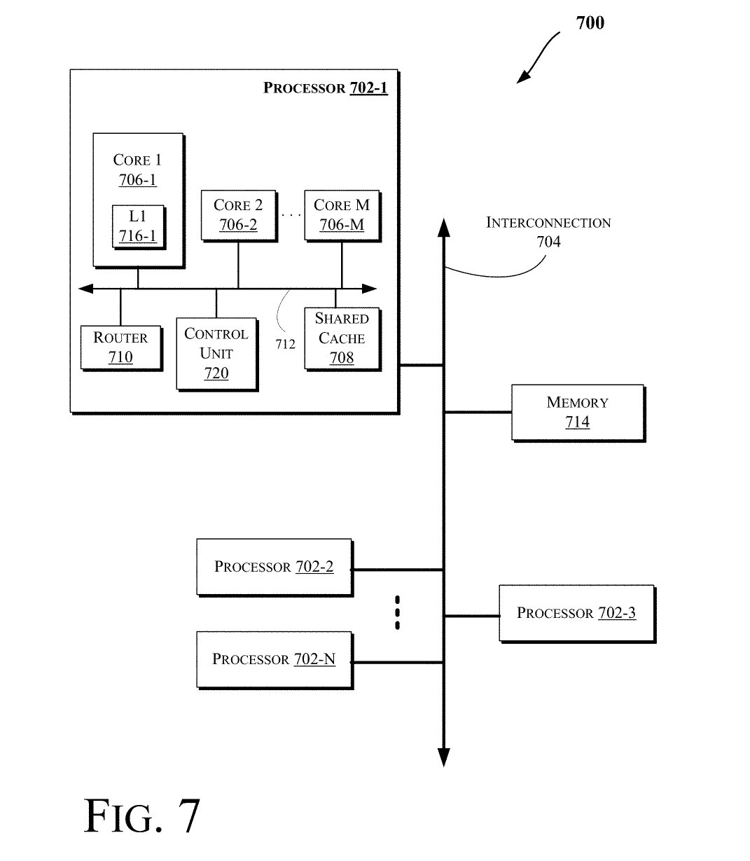

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L 1 cache 716”).

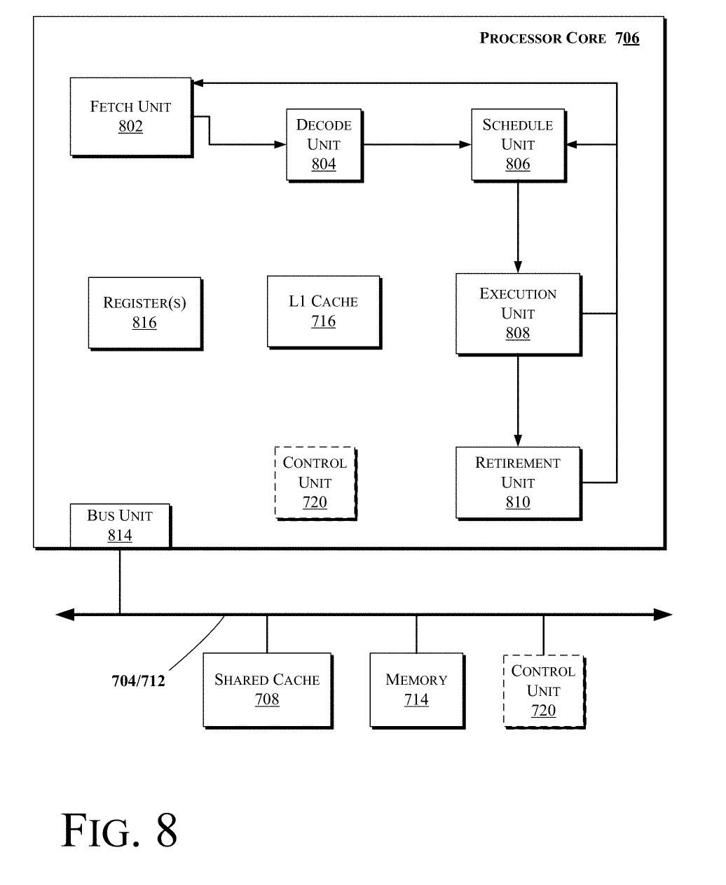

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

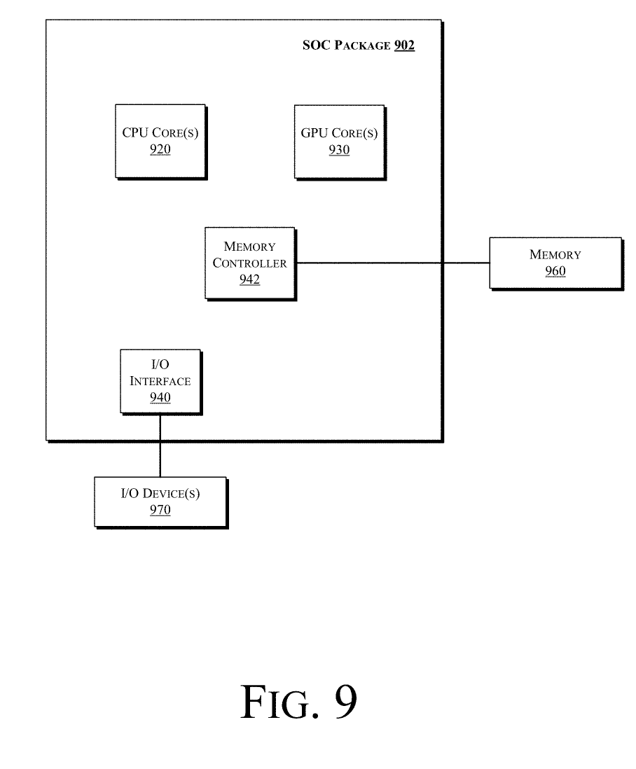

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

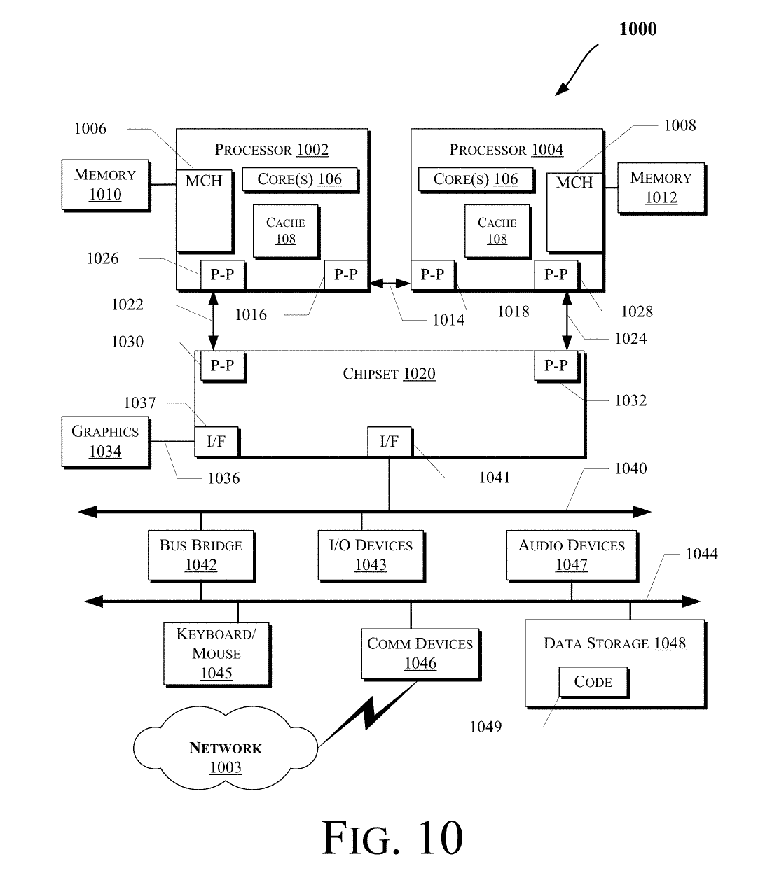

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following examples pertain to further examples.

Example 1 is a stem for lidar data classification, comprising a plurality of sensors comprising a communication interface to receive a lidar dataset comprising a plurality of intensity measurement data points; and processing circuitry to implement an iterative process to determine a second central moment and a fourth central moment of at least a portion of the dataset of intensity measurement data points; determine a kurtosis of the at least a portion of the dataset of intensity measurement data points using the second central moment and the fourth central moment; dentify an intensity measurement data point which has the highest intensity in the at least a portion of the dataset of intensity measurement data points; and remove from the at least a portion of the data set the intensity measurement data point which has the highest intensity in the at least a portion of the dataset of intensity measurement data points until the kurtosis converges to a predetermined value.

In Example 2, the subject matter of Example 1 can optionally include processing circuitry to classify the at least a portion of the data set as a plane.

In Example 3, the subject matter of any one of Examples 1-2 can optionally include an arrangement in which the controller comprises processing circuitry to perform a matrix multiplication transformation to compute a set of raw moments for the at least a portion of the dataset of intensity measurement data points.

In Example 4, the subject matter of any one of Examples 1-3 can optionally include an arrangement in which the controller comprises processing circuitry to compute the second central moment and the fourth central moment from the set of raw moments for the at least a portion of the dataset of intensity measurement data points.

In Example 5, the subject matter of any one of Examples 1-4 can optionally include an arrangement in which the controller comprises processing circuitry to compute the kurtosis of the kurtosis of the at least a portion of the dataset of intensity measurement data points using the formula,

$$k = \frac{{C}_{N}^{4}}{{( {C}_{N}^{2} )}^{2}}$$

where C_{N}² is the second central moment; and C_{N}⁴ is the fourth central moment.

In Example 6, the subject matter of any one of Examples 1-5 can optionally include an arrangement wherein the matrix multiplication transformation computes the following:

$$[ \begin{matrix}{M}_{N}^{0} \\ {M}_{N}^{1} \\ {M}_{N}^{2} \\ {M}_{N}^{3} \\ {M}_{N}^{4}\end{matrix} ] = {[ \begin{matrix}1 & 0 & 0 & 0 & 0 \\ 1 & 1 & 0 & 0 & 0 \\ 1 & \frac{3}{2} & \frac{1}{2} & 0 & 0 \\ 1 & \frac{11}{6} & 1 & \frac{1}{6} & 0 \\ 1 & \frac{50}{24} & \frac{35}{24} & \frac{10}{24} & \frac{1}{24}\end{matrix} ]}^{- 1} [ \begin{matrix}y 0 \\ y 1 \\ y 2 \\ y 3 \\ y 4\end{matrix} ] = [ \begin{matrix}1 & 0 & 0 & 0 & 0 \\ - 1 & 1 & 0 & 0 & 0 \\ 1 & - 3 & 2 & 0 & 0 \\ - 1 & 7 & - 12 & 6 & 0 \\ 1 & 15 & 50 & - 60 & 24\end{matrix} ] [ \begin{matrix}y 0 \\ y 1 \\ y 2 \\ y 3 \\ y 4\end{matrix} ] \qquad$$

where:
M_{N}⁰ is the zeroth raw moment; M_{N}¹ is the first raw moment;

M_{N}² is the second raw moment;

M_{N}³ is the third raw moment; and

M_{N}⁴ is the fourth raw moment.

In Example 7, the subject matter of any one of Examples 1-6 can optionally include an arrangement wherein the processing circuitry to compute the matrix multiplication transformation comprises a series of single-pole infinite impulse response filters, wherein each single-pole infinite impulse response filter comprises an accumulator and a feedback delay.

In Example 8, the subject matter of any one of Examples 1-7 can optionally include an arrangement wherein the remote communication device comprises a vehicle alarm.

In Example 9, the subject matter of any one of Examples 1-8 can optionally include an arrangement wherein the controller comprises wherein the processing circuitry to compute the matrix multiplication transformation comprises a first series of multipliers and adders to compute the second central moment; and a second series of multipliers and adders to compute the fourth central moment.

In Example 10, the subject matter of any one of Examples 1-9 can optionally include an arrangement in which the controller comprises wherein the processing circuitry to compute the matrix multiplication transformation comprises a divider to divide the fourth central moment by the second central moment.

Example 11 is an autonomous vehicle comprising a lidar system to generate a lidar dataset comprising a plurality of intensity measurement data points; and a controller comprising a communication interface to receive the lidar dataset; and processing circuitry to implement an iterative process to determine a second central moment and a fourth central moment of at least a portion of the dataset of intensity measurement data points; determine a kurtosis of the at least a portion of the dataset of intensity measurement data points using the second central moment and the fourth central moment; identify an intensity measurement data point which has the highest intensity in the at least a portion of the dataset of intensity measurement data points; and remove from the at least a portion of the data set the intensity measurement data point which has the highest intensity in the at least a portion of the dataset of intensity measurement data points until the kurtosis converges to a predetermined value.

In Example 12, the subject matter of Example 11 can optionally include processing circuitry to classify the at least a portion of the data set as a plane.

In Example 13, the subject matter of any one of Examples 11-12 can optionally include an arrangement in which the controller comprises processing circuitry to perform a matrix multiplication transformation to compute a set of raw moments for the at least a portion of the dataset of intensity measurement data points.

In Example 14, the subject matter of any one of Examples 11-13 can optionally include an arrangement in which the controller comprises processing circuitry to compute the second central moment and the fourth central moment from the set of raw moments for the at least a portion of the dataset of intensity measurement data points.

In Example 15, the subject matter of any one of Examples 11-14 can optionally include an arrangement in which the controller comprises processing circuitry to compute the kurtosis of the kurtosis of the at least a portion of the dataset of intensity measurement data points using the formula,

$$k = \frac{{C}_{N}^{4}}{{( {C}_{N}^{2} )}^{2}}$$

where C_{N}² is the second central moment; and C_{N}⁴ is the fourth central moment.

In Example 16, the subject matter of any one of Examples 11-15 can optionally include an arrangement wherein the matrix multiplication transformation computes the following:

$$[ \begin{matrix}{M}_{N}^{0} \\ {M}_{N}^{1} \\ {M}_{N}^{2} \\ {M}_{N}^{3} \\ {M}_{N}^{4}\end{matrix} ] = {[ \begin{matrix}1 & 0 & 0 & 0 & 0 \\ 1 & 1 & 0 & 0 & 0 \\ 1 & \frac{3}{2} & \frac{1}{2} & 0 & 0 \\ 1 & \frac{11}{6} & 1 & \frac{1}{6} & 0 \\ 1 & \frac{50}{24} & \frac{35}{24} & \frac{10}{24} & \frac{1}{24}\end{matrix} ]}^{- 1} [ \begin{matrix}y 0 \\ y 1 \\ y 2 \\ y 3 \\ y 4\end{matrix} ] = [ \begin{matrix}1 & 0 & 0 & 0 & 0 \\ - 1 & 1 & 0 & 0 & 0 \\ 1 & - 3 & 2 & 0 & 0 \\ - 1 & 7 & - 12 & 6 & 0 \\ 1 & 15 & 50 & - 60 & 24\end{matrix} ] [ \begin{matrix}y 0 \\ y 1 \\ y 2 \\ y 3 \\ y 4\end{matrix} ] \qquad$$

where:
M_{N}⁰ is the zeroth raw moment;
M_{N}¹ is the first raw moment;
M_{N}² is the second raw moment;
M_{N}³ is the third raw moment; and
M_{N}⁴ is the fourth raw moment.

In Example 17, the subject matter of any one of Examples 11-16 can optionally include an arrangement wherein the processing circuitry to compute the matrix multiplication transformation comprises a series of single-pole infinite impulse response filters, wherein each single-pole infinite impulse response filter comprises an accumulator and a feedback delay.

In Example 18, the subject matter of any one of Examples 11-17 can optionally include an arrangement wherein the remote communication device comprises a vehicle alarm.

In Example 19, the subject matter of any one of Examples 11-18 can optionally include an arrangement wherein the controller comprises wherein the processing circuitry to compute the matrix multiplication transformation comprises a first series of multipliers and adders to compute the second central moment; and a second series of multipliers and adders to compute the fourth central moment.

In Example 20, the subject matter of any one of Examples 1-9 can optionally include an arrangement in which the controller comprises wherein the processing circuitry to compute the matrix multiplication transformation comprises a divider to divide the fourth central moment by the second central moment.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A system for lidar data classification, comprising:
a communication interface to receive a lidar dataset comprising a plurality of intensity measurement data points; and
processing circuitry to implement an iterative process to:
determine a second central moment and a fourth central moment of at least a portion of the dataset of intensity measurement data points;
determine a kurtosis of the at least a portion of the dataset of intensity measurement data points using the second central moment and the fourth central moment;
identify an intensity measurement data point which has the highest intensity in the at least a portion of the dataset of intensity measurement data points; and
remove from the at least a portion of the data set the intensity measurement data point which has the highest intensity in the at least a portion of the dataset of intensity measurement data points until the kurtosis converges to a predetermined value.

2. The system of claim 1, comprising processing circuitry to:
classify the at least a portion of the data set as a plane.

3. The system of claim 1, comprising processing circuitry to:
perform a matrix multiplication transformation to compute a set of raw moments for the at least a portion of the dataset of intensity measurement data points.

4. The system of claim 3, comprising processing circuitry to:
compute the second central moment and the fourth central moment from the set of raw moments for the at least a portion of the dataset of intensity measurement data points.

5. The system of claim 4, comprising processing circuitry to:
compute the kurtosis of the kurtosis of the at least a portion of the dataset of intensity measurement data points using the formula,
$$k = \frac{{C}_{N}^{4}}{{( {C}_{N}^{2} )}^{2}}$$
where:
C_{N}² is the second central moment; and
C_{N}⁴ is the fourth central moment.

6. The system of claim 3, wherein the matrix multiplication transformation computes the following:
$$[ \begin{matrix}{M}_{N}^{0} \\ {M}_{N}^{1} \\ {M}_{N}^{2} \\ {M}_{N}^{3} \\ {M}_{N}^{4}\end{matrix} ] = {[ \begin{matrix}1 & 0 & 0 & 0 & 0 \\ 1 & 1 & 0 & 0 & 0 \\ 1 & \frac{3}{2} & \frac{1}{2} & 0 & 0 \\ 1 & \frac{11}{6} & 1 & \frac{1}{6} & 0 \\ 1 & \frac{50}{24} & \frac{35}{24} & \frac{10}{24} & \frac{1}{24}\end{matrix} ]}^{- 1} [ \begin{matrix}y 0 \\ y 1 \\ y 2 \\ y 3 \\ y 4\end{matrix} ] = [ \begin{matrix}1 & 0 & 0 & 0 & 0 \\ - 1 & 1 & 0 & 0 & 0 \\ 1 & - 3 & 2 & 0 & 0 \\ - 1 & 7 & - 12 & 6 & 0 \\ 1 & 15 & 50 & - 60 & 24\end{matrix} ] [ \begin{matrix}y 0 \\ y 1 \\ y 2 \\ y 3 \\ y 4\end{matrix} ] \qquad$$
where:
M_{N}⁰ is the zeroth raw moment;
M_{N}¹ is the first raw moment;
M_{N}² is the second raw moment;
M_{N}³ is the third raw moment; and
M_{N}⁴ is the fourth raw moment.

7. The system of claim 6, wherein the processing circuitry to compute the matrix multiplication transformation comprises:
a series of single-pole infinite impulse response filters, wherein each single-pole infinite impulse response filter comprises an accumulator and a feedback delay.

8. The system of claim 7, wherein the matrix multiplication transformation computes the following:
$${\hat{H}}_{p} ( z ) = \frac{1}{{( z - 1 )}^{p + 1}}$$

9. The system of claim 8, wherein the processing circuitry to compute the matrix multiplication transformation comprises:
a first series of multipliers and adders to compute the second central moment; and
a second series of multipliers and adders to compute the fourth central moment.

10. The system of claim 9, wherein the processing circuitry to compute the matrix multiplication transformation comprises:
a divider to divide the fourth central moment by the second central moment.

11. An autonomous vehicle, comprising:
a lidar system to generate a lidar dataset comprising a plurality of intensity measurement data points; and
a controller comprising:
a communication interface to receive the lidar dataset; and
processing circuitry to implement an iterative process to:
determine a second central moment and a fourth central moment of at least a portion of the dataset of intensity measurement data points;
determine a kurtosis of the at least a portion of the dataset of intensity measurement data points using the second central moment and the fourth central moment;
identify an intensity measurement data point which has the highest intensity in the at least a portion of the dataset of intensity measurement data points; and
remove from the at least a portion of the data set the intensity measurement data point which has the highest intensity in the at least a portion of the dataset of intensity measurement data points until the kurtosis converges to a predetermined value.

12. The autonomous vehicle of claim 11, comprising processing circuitry to:
classify the at least a portion of the data set as a plane.

13. The autonomous vehicle of claim 11, comprising processing circuitry to:
perform a matrix multiplication transformation to compute a set of raw moments for the at least a portion of the dataset of intensity measurement data points.

14. The autonomous vehicle of claim 13, comprising processing circuitry to:
compute the second central moment and the fourth central moment from the set of raw moments for the at least a portion of the dataset of intensity measurement data points.

15. The autonomous vehicle of claim 14, comprising processing circuitry to:
compute the kurtosis of the kurtosis of the at least a portion of the dataset of intensity measurement data points using the formula,
$$k = \frac{{C}_{N}^{4}}{{( {C}_{N}^{2} )}^{2}}$$
where:
C_{N}² is the second central moment; and
C_{N}⁴ is the fourth central moment.

16. The autonomous vehicle of claim 13, wherein the matrix multiplication transformation computes the following:
$$[ \begin{matrix}{M}_{N}^{0} \\ {M}_{N}^{1} \\ {M}_{N}^{2} \\ {M}_{N}^{3} \\ {M}_{N}^{4}\end{matrix} ] = {[ \begin{matrix}1 & 0 & 0 & 0 & 0 \\ 1 & 1 & 0 & 0 & 0 \\ 1 & \frac{3}{2} & \frac{1}{2} & 0 & 0 \\ 1 & \frac{11}{6} & 1 & \frac{1}{6} & 0 \\ 1 & \frac{50}{24} & \frac{35}{24} & \frac{10}{24} & \frac{1}{24}\end{matrix} ]}^{- 1} [ \begin{matrix}y 0 \\ y 1 \\ y 2 \\ y 3 \\ y 4\end{matrix} ] = [ \begin{matrix}1 & 0 & 0 & 0 & 0 \\ - 1 & 1 & 0 & 0 & 0 \\ 1 & - 3 & 2 & 0 & 0 \\ - 1 & 7 & - 12 & 6 & 0 \\ 1 & 15 & 50 & - 60 & 24\end{matrix} ] [ \begin{matrix}y 0 \\ y 1 \\ y 2 \\ y 3 \\ y 4\end{matrix} ] \qquad$$
where:
M_{N}⁰ is the zeroth raw moment;
M_{N}¹ is the first raw moment;
M_{N}² is the second raw moment;
M_{N}³ is the third raw moment; and
M_{N}⁴ is the fourth raw moment.

17. The autonomous vehicle of claim 16, wherein the processing circuitry to compute the matrix multiplication transformation comprises:
a series of single-pole infinite impulse response filters, wherein each single-pole infinite impulse response filter comprises an accumulator and a feedback delay.

18. The autonomous vehicle of claim 17, wherein the matrix multiplication transformation computes the following:
$${\hat{H}}_{p} ( z ) = \frac{1}{{( z - 1 )}^{p + 1}}$$

19. The autonomous vehicle of claim 18, wherein the processing circuitry to compute the matrix multiplication transformation comprises:
a first series of multipliers and adders to compute the second central moment; and
a second series of multipliers and adders to compute the fourth central moment.

20. The autonomous vehicle of claim 19, wherein the processing circuitry to compute the matrix multiplication transformation comprises:
a divider to divide the fourth central moment by the second central moment.
